(19) United States
(12) Patent Application Publication
(10) Pub. No.: US 2013/0272391 A1
(43) Pub. Date: Oct. 17, 2013

(54) Method and Apparatus of Quantization Matrix Coding

(71) Applicant: FUTUREWEI TECHNOLOGIES, INC., Plano, TX (US)

(72) Inventors: Jianhua Zheng, Beijing (CN); Jianwen Chen, Los Angeles, CA (US); Jingsheng Cong, Pacific Palisades, CA (US)

(73) Assignee: Futurewei Technologies, Inc., Plano, TX (US)

(21) Appl. No.: 13/864,054

(22) Filed: Apr. 16, 2013

Related U.S. Application Data
(60) Provisional application No. 61/624,877, filed on Apr. 16, 2012.

(51) Int. Cl. H04N 7/26

(52) U.S. Cl. CPC H04N 19/00096
USPC 375/240.03

(57) ABSTRACT

A method of coding a quantization matrix (QM) comprising non-uniformly downsampling the QM to generate a plurality of downsampled quantization coefficients. Also, an apparatus used in video encoding comprising a processor configured to non-uniformly downsample a QM to generate a plurality of downsampled quantization coefficients, scan the downsampled quantization coefficients, and encode the downsampled quantization coefficients based on scanning the downsampled quantization coefficients to generate encoded coefficients, and a transmitter coupled to the processor and configured to transmit a bitstream comprising a picture parameter set containing the encoded coefficients.

### CROSS-REFERENCE TO RELATED APPLICATIONS

The present application claims priority to U.S. Provisional Patent Application No. 61/624,877 filed Apr. 16, 2012 by Jianhua Zheng et al. and entitled “Method and Apparatus of Quantization Matrix Coding”, which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The amount of video data needed to depict even a relatively short film can be substantial, which may result in difficulties when the data is to be streamed or otherwise communicated across a communications network with limited bandwidth capacity. Thus, video data is generally compressed before being communicated across modern day telecommunications networks. Video compression devices often use software and/or hardware at the source to code the video data prior to transmission, thereby decreasing the quantity of data needed to represent digital video images. The compressed data is then received at the destination by a video decompression device that decodes the video data. With limited network resources and ever increasing demands of higher video quality, improved compression and decompression techniques that improve compression ratio with little to no sacrifice in image quality are desirable.

For example, in current high efficiency video coding (HEVC) designs, transform and quantization matrix (QM) sizes can go up to 32×32. Large block transforms may provide improved coding efficiency, but also lead to larger overhead for carrying the perceptual QMs in the picture parameter sets. In HEVC there can be a total of 24 QMs used and stored in one picture, as there may be separate QMs for 4×4, 8×8, 16×16 and 32×32 blocks, inter-frame (in short as inter) prediction and intra-frame (in short as intra) prediction, and luminance (Y) and chrominance (U and V) components. It has been reported that such an overhead may be roughly 10 times of that of advanced video coding (AVC) if the AVC QM compression method is used. Therefore, it may be desirable to improve the compression efficiency of QMs, especially for large block sizes, to reduce the generated bits in a bit stream.

### SUMMARY

In one embodiment, the disclosure includes a method of coding a quantization matrix (QM) comprising non-uniformly downsampling the QM to generate a plurality of downsampled quantization coefficients.

In another embodiment, the disclosure includes an apparatus used in video decoding comprising a processor configured to acquire a bitstream comprising a plurality of encoded quantization coefficients corresponding to one QM, decode the encoded quantization coefficients to generate a plurality of quantization coefficients and a plurality of downsampled quantization coefficients, upsample the plurality of downsampled quantization coefficients to generate a plurality of upsampled quantization coefficients, and generate a reconstructed QM by combining the quantization coefficients and the upsampled quantization coefficients.

In yet another embodiment, the disclosure includes a method of video decoding comprising acquiring a received bitstream comprising a plurality of encoded quantization coefficients corresponding to one QM, decoding the encoded quantization coefficients to generate a plurality of quantization coefficients and a plurality of downsampled quantization coefficients, upsampling the plurality of downsampled quantization coefficients to generate a plurality of upsampled quantization coefficients, and generating a reconstructed QM by combining the quantization coefficients and the upsampled quantization coefficients.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates part of an examplary video encoder.

FIG. 2A illustrates an embodiment of a QM encoding scheme.

FIG. 2B illustrates an embodiment of a QM decoding scheme.

FIG. 3A illustrates an embodiment of a 16×16 QM downsampling scheme.

FIG. 3B illustrates an embodiment of a quantization coefficient coding scheme.

FIG. 4A illustrates an embodiment of a 32×32 QM downsampling scheme.

FIG. 4B illustrates an embodiment of a quantization coefficient coding scheme.

FIG. 5A illustrates an embodiment of a 16×16 QM downsampling scheme.

FIG. 5B illustrates an embodiment of a quantization coefficient coding scheme.

FIG. 6A illustrates an embodiment of a 32×32 QM downsampling scheme.

FIG. 6B illustrates an embodiment of a quantization coefficient coding scheme.

FIG. 7 illustrates an embodiment of a bit shifting scheme.

FIG. 8 illustrates an embodiment of a bit shifting scheme.

FIG. 9 illustrates an embodiment of a zigzag scanning scheme.

FIG. 10 illustrates an embodiment of a zigzag scanning scheme.

FIG. 11 illustrates an embodiment of a quantization coefficient scanning scheme.

FIG. 12 illustrates an embodiment of a quantization coefficient scanning scheme.

FIG. 13 illustrates an embodiment of an upsampling precision map.

FIG. 14 illustrates an embodiment of an upsampling precision map.

FIG. 15 illustrates an embodiment of an upsampling algorithm.

FIG. 16 illustrates an embodiment of a QM encoding method.

FIG. 17 illustrates an embodiment of a QM decoding method.

FIG. 18 is a schematic diagram of an embodiment of a network node.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

When coding a block of pixels in a picture or video frame, a prediction block may be generated based on one or more previously coded reference blocks using either inter prediction or intra prediction. The prediction block may be an estimated version of the original block. A residual block may be generated by subtracting the original block from the prediction block, or vice versa, which may represent prediction residuals or errors. Since an amount of data needed to represent the prediction residuals may typically be less than an amount of data needed to represent the original block, the residual block may be encoded to achieve a higher compression ratio.

Then, residual values of the residual block in a spatial domain may be converted to transform coefficients in a frequency domain. The conversion may be realized through a two-dimensional transform, e.g. a transform that closely resemble discrete cosine transform (DCT). In a transform matrix, low-index transform coefficients (e.g., located in a top-left region) may correspond to big spatial features and have relatively high magnitudes, while high-index transform coefficients (e.g., located in a bottom-right region) may correspond to small spatial features and have relatively small magnitudes. Further, a quantization matrix (QM) comprising quantization coefficients may be applied to the transform matrix, thereby quantizing all transform coefficients to become quantized transform coefficients. As a result of quantization, the scale or magnitude of transform coefficients may be reduced. Some high-index transform coefficients may be reduced to zero, which may then be skipped in subsequent scanning and coding steps.

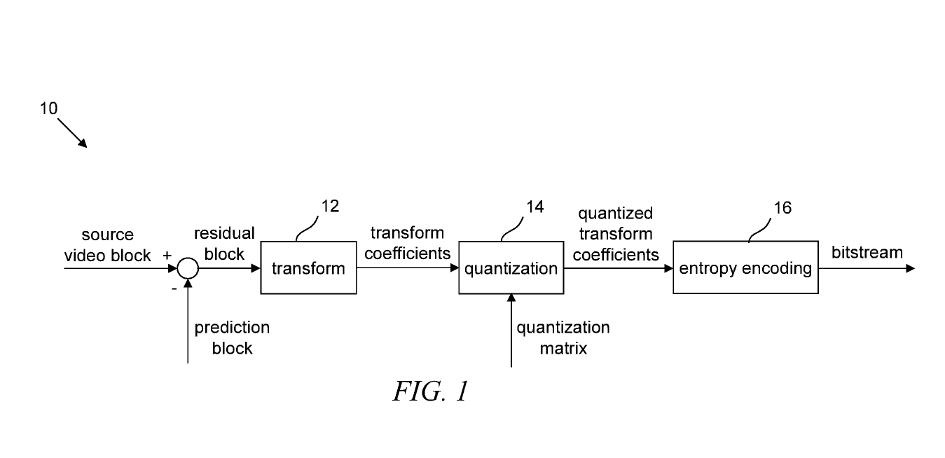

FIG. 1 illustrates part of an examplary video encoder 10 comprising a transform unit or module 12, a quantization module 14, and an entropy encoder or encoding module 16. Although not shown in FIG. 1, it should be understood that other modules, such as prediction module, dequantization module, reconstruction module, etc., may also be present in the video encoder 10. In operation, the video encoder 10 may obtain or acquire a source picture or video frame, which may multiple video blocks. In the interest of clarity, the encoding of one source video block is considered here as an example. To encode the video block, a prediction block may first be generated as an estimation of the video block. Recall that the prediction block may be generated via inter or intra prediction by a prediction module. Then, a difference between the source video block and the prediction block may be computed to generate a residual block. The residual block may be transformed by the transform module 12 into transform coefficients. During transform, residual pixel values in a spatial domain, which comprises big features and small features, are converted to transform coefficients in a frequency domain, which comprises high frequency bands and low frequency bands. Afterwards, the quantization module may use a QM to quantize the transform coefficients, thereby generating quantized transform coefficients. Further, the quantized transform coefficients may be encoded by the entropy encoding module and eventually transmitted from the video encoder 10 as part of a bitstream.

It can be seen from the video encoder 10 that a QM is used as an integral part of the video encoding process. Configuration of the QM may determine how much information of the transform coefficients to preserve or filter out, thus the QM may impact coding efficiency as well as coding quality. In fact, the QM may be needed not only in an encoder but also in a decoder. Specifically, to correctly decode pictures, information regarding quantization coefficients in QMs needs to be encoded in an encoder and transmitted from the encoder to the decoder. In video coding techniques and standards, a QM may sometimes be referred to as a scaling matrix or a weighting matrix. Thus, the term “QM” used herein may be a general term covering scaling matrix, weighting matrix, quantization matrix, and other equivalent terms.

Current HEVC design may use four block sizes: 4×4, 8×8, 16×16, and 32×32. Further, there may be separate QMs for 4×4, 8×8, 16×16, and 32×32 blocks, separate QMs for intra prediction and inter prediction, and separate QMs for YUV components. Accordingly, there may be a total of 24 (i.e., 4×2×3) QMs. If 16×16 and 32×32 blocks are considered as larger blocks (note that terms such as larger and smaller are relative terms, thus their corresponding sizes may vary depending on context), a number of quantization coefficients in the larger blocks may be computed or calculated as: (16×16+32×32)×2×3=7680, which indicates that 7680 quantization coefficients need to be coded and stored in picture parameter sets (PPS). Furthermore, each quantization coefficient may have a value ranging from 0 to 63 (if coefficient has 8 bits), resulting in a total of 7680×8=61440 bits=60 k bits in each video frame. This overhead data may not have a huge size, but compared with bits used for coding quantized residual pixels for one video frame, the overhead data size may be significant. Typically, the bit consumption for a well-compressed high definition (HD) video frame may be about 50 k˜500 k.

In addition, if the size of QMs is extended upward to 32×32 as in HEVC, it has been found that data size needed to store QMs may be about 16 times larger than the AVC standard (sometimes referred to as H.264), which may use 4×4 and 8×8 block sizes. In H.264, a QM may be coded by differential pulse code modulation (DPCM). It has been reported that, if the H.264 QM compression method is directly used in HEVC, the QM overhead may be roughly 10 times that of H.264. Therefore, efficient coding of QMs may be desired in HEVC.

In HEVC, QMs of larger sizes (e.g. 16×16 and 32×32) may be used and stored as separate 8×8 QMs in a PPS and/or a sequence parameter set (SPS). For example, on an encoder side, a larger QM may be downsampled or subsampled into an 8×8 matrix. On a decoder side, the larger QM may be reconstructed from the downsampled 8×8 matrix via upsampling methods. Overall, the downsampled 8×8 QMs may hold all downsampled values of 16×16 matrices or 32×32 matrices to reduce the stored bits. The downsampled values in the separated 8×8 matrix may be the average values of 4×4 frequency neighboring components in a 16×16 or 32×32 matrix.

However, the statistical property of transform (e.g., DCT) coefficients in larger transform matrices may be different from those in smaller blocks. For example, a number of non-zero coefficients in a 32×32 transform matrix may be greater than that in an 8×8 transform matrix. Thus, the coefficients energy in the 32×32 transform matrix may be more concentrated to the low frequency part (corresponding to the top-left region of the matrix), if compared to the 8×8 transform matrix. If a 32×32 QM is reconstructed from the downsampled 8×8 QM, the weighting values in the 8×8 matrix may be mapped to the 32×32 QM by value duplication, which may introduce frequency band mapping error and result in subjective artifacts.

Disclosed herein are apparatuses, systems, schemes, and methods to improve QM coding and reconstruction. In this disclosure, a non-uniform downsampling scheme is described to store quantization coefficients of a larger QM using a smaller QM. Specifically, low frequency components located in a top-left region of the QM may be copied or kept unchanged, which may protect the more important low frequency components and reduce frequency band mapping error. On the other hand, high frequency components located in other regions may be downsampled using one or more downsampling filter sizes, which may help reduce a total number of quantization coefficients. Further, the downsampled quantization coefficients may be lossy coded, e.g., using right bit shifting. After downsampling or lossy coding, the downsampled quantization coefficients may be scanned following various orders, such as a zigzag order. Upsampling may also be performed using value duplication or interpolation algorithms. Overall, embodiments disclosed herein may help reduce necessary QM bits in a bitstream and QM reconstruction error.

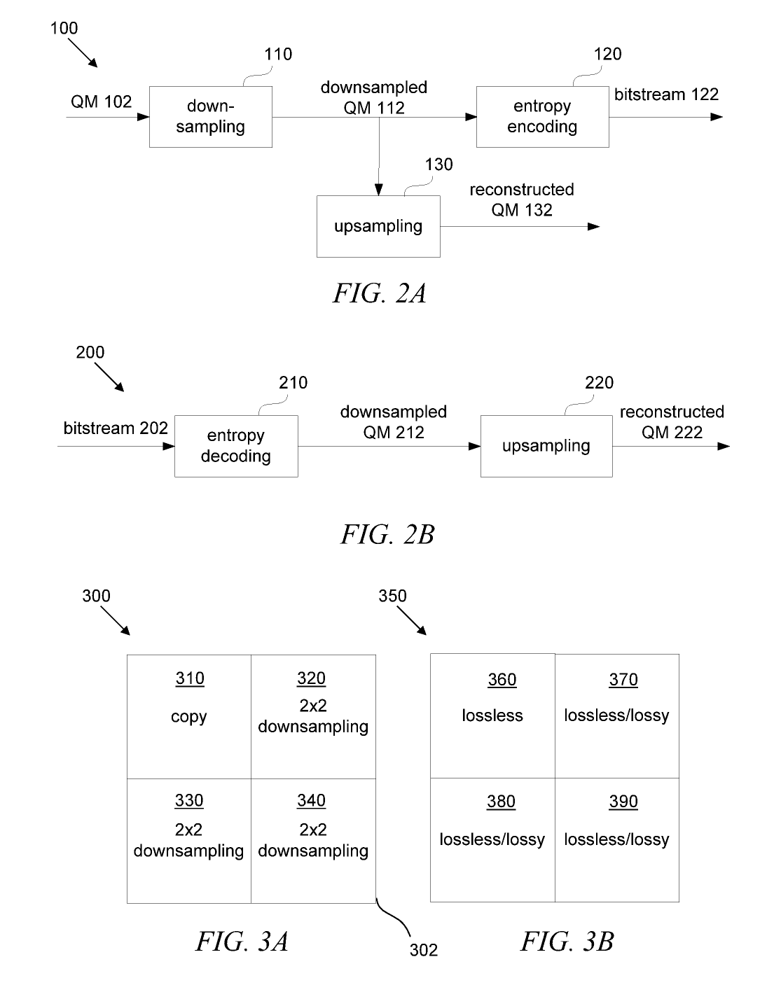

FIG. 2A illustrates an embodiment of a QM encoding scheme 100 implemented in a video encoder. In the QM encoding scheme 100, a QM 102 may feed into a downsampling module or unit 110, which may be configured to convert the QM 102 into a downsampled QM 112. The term “downsampling” may be used herein interchangeably with “subsampling”. The downsampling unit 110 may use one or more downsampling filters to process the QM 102. Different filter sizes of downsampling filters applied on the QM 102 may cause the downsampled QM 112 to have different sizes. For example, if a 2×2 downsampling filter is used, the downsampled QM 112 ends up having a width and height equaling half of that of the QM 102. That is, a 16×16 QM 102 processed by a 2×2 downsampling filter leads to a 8×8 downsampled QM 112, while the 16×16 QM 102 processed by a 4×4 downsampling filter leads to a 4×4 downsampled QM 112. In use, the QM 102 may typically have a relatively large size, such as 16×16 or 32×32, while the size of the downsampled QM 112 may typically be 8×8, but it should be understood that principles taught herein are applicable to QMs of any reasonable size.

In an embodiment, the downsampling unit 110 is configured to non-uniformly downsample the QM 102 to generate the downsampled QM 112, which comprises a plurality of downsampled quantization coefficients. In some embodiments, the downsampled quantization coefficients may be further processed, e.g., via lossless and/or lossy coding (e.g., bit shifting), which may reduce total bit widths. Then, the downsampled quantization coefficients may be encoded by an entropy encoding unit 120. A bitstream 122 may be generated comprising downsampled quantization coefficients, e.g., in the PPS of a picture or video frame, or the SPS or video parameter set (VPS) of a video. The bitstream 122 may be transmitted to a corresponding decoder. Note that prior to entropy encoding, the quantization coefficients in the QM 112 may be scanned to determine an optimal order of entropy encoding, which may help improve encoding efficiency.

In addition to entropy encoding, downsampled quantization coefficients in the downsampled QM 112 may be upsampled by an upsampling unit 130, thereby generating a reconstructed QM 132. The upsampling unit 130 may employ a number of upsampling algorithms which are described herein later. The reconstructed QM 132 may be used for other purposes, such as constructing other quantization matrix, which may be used in coding other block chrominance component. A person of ordinary skill in the art will recognize that the QM encoding scheme 100 only includes a portion of all modules or units present in a video encoder, thus other modules or units not shown in FIG. 2A may be added as appropriate, if needed.

FIG. 2B illustrates an embodiment of a QM decoding scheme 200, which may correspond to the QM encoding scheme 100 and be implemented in a video decoder. In the QM decoding scheme 200, a bitstream 202 comprising encoded and subsampled QMs (e.g., in PPS, SPS or VPS) may feed into an entropy decoding unit 210. Taking one QM as an example, the entropy decoding unit 210 decodes encoded quantization coefficients in the QM, thereby generating a downsampled (and decoded) QM 212. The downsampled QM 212 comprises decoded quantization coefficients, at least some of which have been downsampled.

Recall that the encoded and downsampled coefficients have been generated in an encoder via non-uniform downsampling, which uses one or more downsampling filters with specific algorithms and filter sizes. To correctly reconstruct quantization coefficients, the coefficients need to be non-uniformly upsampled using algorithms corresponding to those used in the downsampling filter(s). Upsampling algorithm information may be pre-programmed into an upsampling unit 220 in the QM decoding scheme 200, or alternatively be contained in the bitstream received by the QM decoding scheme 200. Accordingly, the upsampling unit 220 may upsample the downsampled QM 212 to generate a reconstructed QM 222.

A person of ordinary skill in the art will recognize the correspondence between the QM encoding scheme 100 and the QM decoding scheme 200. To prevent floating errors, corresponding QMs and units in these two schemes may be substantially the same. For example, barring errors caused by transmission, the downsampled QMs 112 and 212 may be the same, the upsampling units 130 and 220 may be the same, and the reconstructed QMs 132 and 222 may be the same. Further, the QM decoding scheme 200 only includes a portion of all modules or units present in a video decoder, thus other modules or units not shown in FIG. 2B may be added as appropriate.

As mentioned above, a larger-sized QM (e.g., QM 102) disclosed herein may be non-uniformly downsampled, which indicates that not all of the quantization coefficients in the QM are downsampled using the same filter size. This may cover various scenarios. In a first scenario, only part of the quantization coefficients in the QM are downsampled using one or more filter sizes, while the remaining coefficients are intact or copied. For instance, the QM may comprise a first region and a second region, both of which may be rectangular or non-rectangular. The first region comprises a top-left corner quantization coefficient corresponding to the lowest frequency quantization component. In this instance, non-uniformly downsampling the QM may comprise downsampling the second region using a downsampling filter with a filter size greater than 1×1, wherein no downsampling is performed in the first region.

In a second scenario of non-uniformly downsampling, all of the coefficients in a QM may be downsampled but with at least two filter sizes. For instance, the QM may comprise a first region and a second region, wherein the first region comprises a top-left corner quantization coefficient. In an embodiment, non-uniformly downsampling the QM comprises downsampling the first region using a downsampling filter with a first filter size, and meanwhile, downsampling the second region using a downsampling filter with a second filter size greater than the first filter size.

Performing no downsampling may sometimes be considered downsampling with a filter size of 1×1, that is, copying or directly using the original quantization coefficients without reducing a number of the quantization coefficients. Downsampling filter with size N×N (N is an integer greater than one) indicates that N×N quantization coefficients in the original QM is used to generate one downsampled quantization coefficient. In an embodiment, if a 2×2 downsampling filter is applied, every 2×2 neighboring quantization coefficients in the original QM are used to generate one downsampled quantization coefficient. Otherwise, if a 4×4 downsampling filter is applied, every 4×4 neighboring quantization coefficients in the original QM are used to generate one downsampled quantization coefficient. Further, a downsampling filter may use any suitable algorithm to generate a downsampled quantization coefficient. For example, using a 4×4 downsampling filter, an average value of 16 original quantization coefficients may be used as the value of the downsampled coefficient. For another example, the downsampled coefficient is interpolated using the whole or some partial of the 16 original quantization coefficients. For yet another example, one of the 16 original quantization coefficients may be picked or selected to be the value of the downsampled coefficient.

Note that the term “region” is used herein as a general term covering sub-matrix, area, section, part, portion, or any other similar term used in a QM. Note that downsampling a region herein means downsampling quantization coefficients residing in that region.

In any scenario, more regions may be present and may be downsampled using more filter sizes. For example, the QM may further comprise a third region, wherein the third region is further away from the top-left corner quantization coefficient than the second region (meaning that the third region has higher frequency components than the second region, which has higher frequency components than the first region). Referring to the first scenario, non-uniformly downsampling the QM may further comprise downsampling the third region using a downsampling filter with filter size greater than the first filter size. The general principles of non-uniformly downsampling a QM should be better understood by a number of embodiments described in the following paragraphs, which use QMs having sizes of 16×16 and 32×32 as examples.

FIG. 3A illustrates an embodiment of a 16×16 QM downsampling scheme 300, which may be implemented as part of a QM coding scheme (e.g., the QM encoding scheme 100). As shown in FIG. 3A, a 16×16 QM 302 may comprise a first region 310, a second region 320, a third region 330, and a fourth region 340, all of which are 8×8 in size. The region 310 is a top-left region corresponding to the low frequency part, the region 320 is a top-right region corresponding to an intermediate frequency part, the region 330 is a bottom-left region corresponding to another intermediate frequency part, and the region 340 is a bottom-right region corresponding to the high frequency part. A person of ordinary skill in the art will understand that top, bottom, left, and right, and other similar terms, are all relative terms, thus their correspondence may change within the principles of the present disclosure. For example, if the QM 302 is manually rotated for any reason, the regions may rotate accordingly still corresponding to their frequency parts.

In video coding, low frequency components corresponding to large spatial features may be visually more important than high frequency components corresponding to small spatial features. Accordingly, in a QM, it may be desirable to preserve more details of its low frequency quantization coefficients residing in a top-left region, while filtering out some less important high frequency quantization coefficients residing in a bottom-right region. This approach may retain most of the visual quality while achieving high compression ratio.

As shown in FIG. 3A, quantization coefficients in the region 310 may be copied or kept unchanged (recall that this may sometimes be considered as downsampling using a 1×1 downsampling filter), while quantization coefficients in each of the regions 320, 330, and 340 may be downsampled by a 2×2 downsampling filter to become a 4×4 region. Accordingly, the QM 302 may be converted to the region 310 and (3*8×8)/(2×2)=48 downsampled coefficients to represent the high frequency weighting components. Hence, the number of weighting values in the 16×16 QM 302 is reduced from 256 to 8×8+(3*8×8)/(2×2)=112. Although the region 310 is shown as copied while the regions 320, 330, and 340 are shown as downsampled, in an alternative embodiment, all regions including the region 310 may be downsampled, as long as a filter size used in the region 310 is smaller than any filter size used in other regions. For instance, the region 310 may employ a 2×2 downsampling filter, while the regions 320, 330, and 340 may employ a 4×4 or bigger downsampling filter. Further, the region 310 may be partially downsampled, e.g., with at least one quantization coefficient (e.g., top-left corner coefficient) not downsampled and with all other quantization coefficients in the region 310 downsampled.

Although the four regions are shown in FIG. 3A as four equally-sized quadrants of the QM 302, it should be understood that the regions may or may not be equal in size. For example, if it is desirable to downsample the 16×16 QM 302 to 8×8=64 downsampled quantization coefficients (matching current HEVC design) instead of 112 downsampled quantization coefficients, the region 310 needs to be smaller than 8×8 (e.g., 7×7 or other suitable sizes). Further, although the regions are shown in FIG. 3A as square regions, some of them may alternatively be rectangular or even non-rectangular regions. For example, when dividing the QM 302, the region 310 may be considered a first rectangular region, while the other regions 320, 330, and 340 may be collectively considered a second non-rectangular region. A person of ordinary skill in the art will understand that these considerations are applicable to other figures disclosed herein.

FIG. 3B illustrates an embodiment of a quantization coefficient coding scheme 350, which may be implemented on coefficients generated by the QM downsampling scheme 300. According to the scheme 300, the 8×8 region 310 generates an 8×8 region 360 comprising original (i.e., not downsampled) quantization coefficients, and the 8×8 regions 320, 330, and 340 generate 4×4 regions 370, 380, and 390, respectively, comprising downsampled quantization coefficients. The scheme 350 may be part of a QM coding scheme (e.g., the QM encoding scheme 100). In the scheme 350, the region 360 may be further lossless coded to avoiding mapping error in low frequency components. The downsampled quantization coefficients in the regions 370, 380, and 390 may also be lossless coded and stored into a bitstream. Alternatively, since the high frequency regions 370, 380, and 390 may be relatively less important than the low frequency region 360, to further quantization matrix compression, downsampled quantization coefficients in the regions 370, 380, and 390 may be lossy coded. In general, lossless coding induces no error or loss of information, while lossy coding may induce some error or loss of information. Any suitable lossless and/or lossy coding algorithms may be used for the coefficients. For example, lossy coding may be realized by right bit shifting to reduce bit width of coefficients, which is further described in later paragraphs.

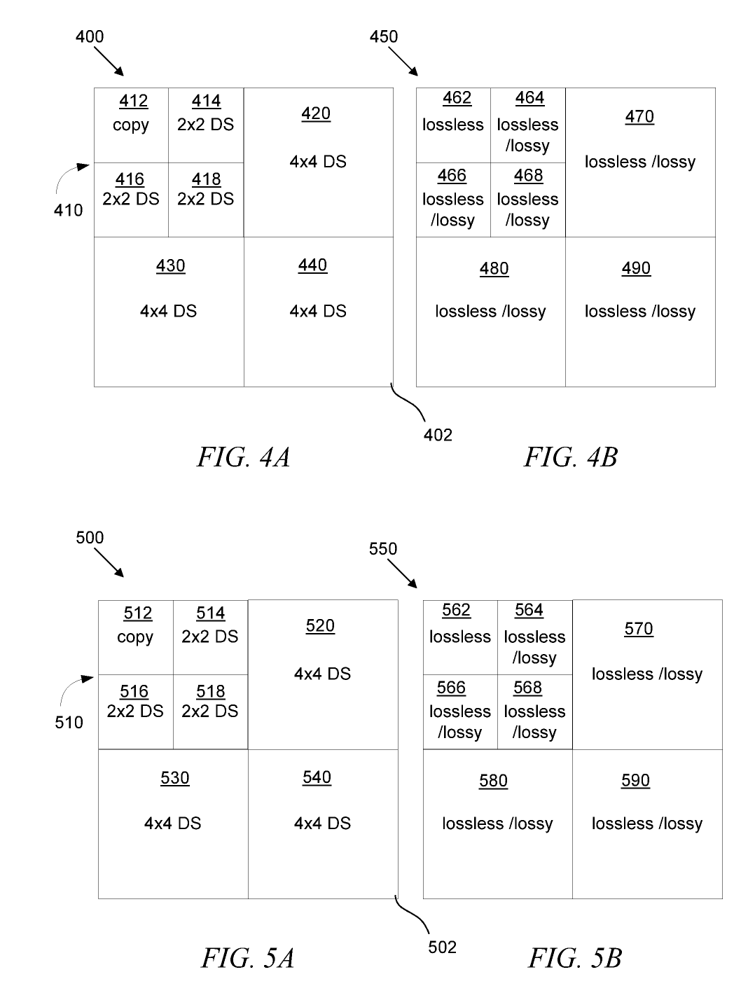

FIG. 4A illustrates an embodiment of a 32×32 QM downsampling scheme 400, which may be implemented as part of a QM coding scheme (e.g., the QM encoding scheme 100). Some aspects of the scheme 400 may be the same as or similar to the scheme 300, thus in the interest of conciseness, the following descriptions will focus on aspects not yet covered. As shown in FIG. 4A, a 32×32 QM 402 may comprise a region 410, a region 420, a region 430, and a region 440, all of which are 16×16 in size and arranged similarly to the QM 302 in FIG. 3A. In comparison to the 16×16 QM 302, since the 32×32 QM 402 is larger in size, its low frequency 16×16 region 410 is further divided into smaller regions (or sub-regions) including a region 412, a region 414, a region 416, and a region 418, all of which are 8×8 in size. The regions 412-418 represent finer frequency ranges of the low frequency part in the region 410. In particular, the region 412 is a top-left region comprising a top-left corner quantization coefficient corresponding to the lowest frequency.

The philosophy of downsampling the larger QM 402 may be the same. That is, preserving more details of the low frequency parts (dense filtering) and less details of the high frequency parts (sparse filtering). Further, the further a region is away from the top-left corner quantization coefficient (i.e., a minimal distance between the region and the top-left corner quantization coefficient is longer), the more sparse the region may be filtered. As shown in FIG. 4A, quantization coefficients in the region 412 may be copied or kept unchanged. Quantization coefficients in each of the 8×8 regions 414, 416, and 418 may be downsampled by a 2×2 downsampling (DS) filter to become a 4×4 region. Quantization coefficients in each of the 16×16 regions 420, 430, and 440 may be downsampled by a 4×4 downsampling filter to become a 4×4 region. Accordingly, the QM 402 may be converted to the region 412 and (3*8×8)/(2×2)=48 downsampled coefficients from the regions 414-418, and another (3*8×8)/(2×2)=48 downsampled coefficients from the regions 420-440. Hence, the number of weighting values in the 32×32 QM 402 is reduced from 1024 to 8×8+(3×256−8×8)/(2×2)+(3×16×161024−256)/4×4=160.

FIG. 4B illustrates an embodiment of a quantization coefficient coding scheme 450, which may be implemented on coefficients generated by the QM downsampling scheme 400. According to the scheme 400, the 8×8 region 412 generates an 8×8 region 462, the 8×8 regions 414, 416, and 418 generate 4×4 regions 464, 466, and 468 respectively, and the 16×16 regions 420, 430, and 440 generate 4×4 regions 470, 480, and 490 respectively. The region 462 comprises original (i.e., not downsampled) quantization coefficients, while all of the regions 464-490 comprise downsampled quantization coefficients. The scheme 450 may be part of a QM coding scheme (e.g., the QM encoding scheme 100). In the scheme 450, the region 462 may be further lossless coded to avoiding mapping error in the low frequency components. The regions 464-490 may also be lossless coded and stored into a bitstream. Alternatively, since the higher frequency regions 464-490 may be relatively less important than the low frequency region 462, to further improve QM compression, downsampled quantization coefficients in the regions 464-490 may be lossy coded. Any suitable lossless and/or lossy coding algorithms may be used for the coefficients. For example, lossy coding may be realized by right bit shifting to reduce bit width of coefficients.

In some embodiments, both 16×16 QM (e.g., QM 302) and 32×32 QM (e.g., QM 402) may be divided into finer regions. FIG. 5A illustrates an embodiment of a 16×16 QM downsampling scheme 500, which may be implemented as part of a QM coding scheme (e.g., the QM encoding scheme 100). Some aspects of the scheme 500 may be the same as or similar to the scheme 300 or scheme 400, thus in the interest of conciseness, the following descriptions will focus on aspects not yet covered. As shown in FIG. 5A, a 16×16 QM 502 may comprise a region 510, a region 520, a region 530, and a region 540, all of which are 8×8 in size and arranged the same as the QM 302 in FIG. 3A. In comparison to the QM 302, in the QM 502, the 8×8 low frequency region 510 is further divided into smaller regions (or sub-regions) including a region 512, a region 514, a region 516, and a region 518, all of which are 4×4 in size. The regions 512-518 represent finer frequency ranges of the low frequency part in the region 510. In particular, the region 512 is a top-left region comprising a top-left corner quantization coefficient corresponding to the lowest frequency component.

As shown in FIG. 5A, quantization coefficients in the region 512 may be copied or kept unchanged. Quantization coefficients in each of the 4×4 regions 514, 516, and 518 may be downsampled by a 2×2 downsampling filter to become a 2×2 region. Quantization coefficients in each of the 8×8 regions 520, 530, and 540 may be downsampled by a 4×4 downsampling filter to become a 2×2 region. Accordingly, the QM 502 may be converted to the region 512, 12 downsampled coefficients from the regions 514-518, and 12 downsampled coefficients from the regions 520-540. Hence, the number of weighting values in the 16×16 QM 502 is reduced from 256 to 4×4+(3×4×4)/2×2+(3*8×8)/(4×4)=16+12+12=40.

FIG. 5B illustrates an embodiment of a quantization coefficient coding scheme 550, which may be implemented on coefficients generated by the QM downsampling scheme 500. According to the scheme 500, the 4×4 region 512 generates a 4×4 region 562, the 4×4 regions 514, 516, and 518 generate 2×2 regions 564, 566, and 568 respectively, and the 8×8 regions 520, 530, and 540 generate 2×2 regions 570, 580, and 590 respectively. The region 562 comprises original (i.e., not downsampled) quantization coefficients, while all of the regions 564-590 comprise downsampled quantization coefficients. The scheme 550 may be part of a QM coding scheme (e.g., the QM encoding scheme 100). In the scheme 550, the region 562 may be further lossless coded to avoiding mapping error in the low frequency components. The regions 564-590 may also be lossless coded and stored into a bitstream. Alternatively, since the higher frequency regions 564-590 may be relatively less important than the low frequency region 562, to further improve QM compression, downsampled quantization coefficients in the regions 564-590 may be lossy coded.

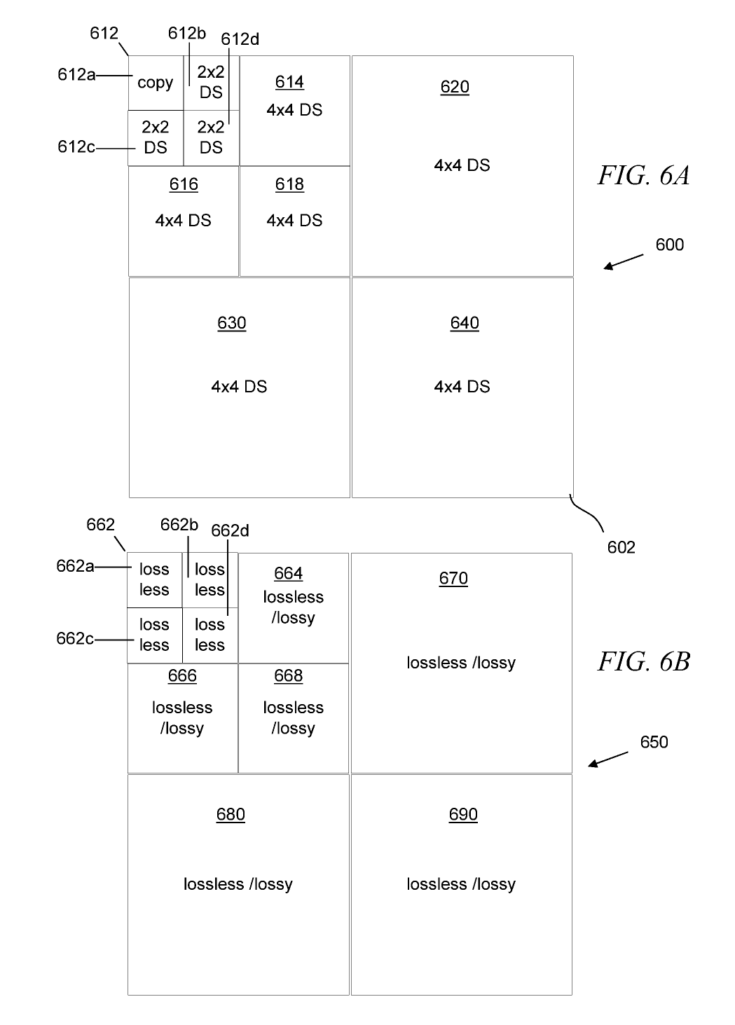

FIG. 6A illustrates an embodiment of a 32×32 QM downsampling scheme 600, which may be implemented as part of a QM coding scheme (e.g., the QM encoding scheme 100). Some aspects of the scheme 600 may be the same as or similar to the scheme 400, thus in the interest of conciseness, the following descriptions will focus on aspects not yet covered. As shown in FIG. 6A, a 32×32 QM 602 may comprise regions 612, 614, 616, 618, 620, 630, and 640, which are arranged the same as the QM 402 in FIG. 4A. In comparison to the QM 402, in the QM 602, the 8×8 low frequency region 612 is further divided into four 4×4 regions (or sub-regions) 612a, 612b, 612c, and 612d. The regions 612a-612d represent finer frequency ranges of the low frequency part in the region 612. In particular, the region 612a is a top-left region comprising a top-left corner quantization coefficient corresponding to the lowest frequency component.

As shown in FIG. 6A, quantization coefficients in the region 612a may be copied or kept unchanged. Quantization coefficients in each of the 4×4 regions 612b, 612c, and 612d may be downsampled by a 2×2 downsampling filter to become a 2×2 region. Quantization coefficients in each of the 8×8 regions 614, 616, and 618 may be downsampled by a 4×4 downsampling filter to become a 2×2 region. Quantization coefficients in each of the 16×16 regions 620, 630, and 640 may also be downsampled by a 4×4 downsampling filter to become a 4×4 region. Accordingly, the QM 602 may be converted to the region 612, 12 downsampled coefficients from the regions 612b-612d, 12 downsampled coefficients from the regions 614-618, and 48 downsampled coefficients from the regions 620-640. Hence, the number of weighting values in the 32×32 QM 602 is reduced from 1024 to 4×4+(3×4×4)/2×2+(3*8×8)/(4×4)+(3*16×16)/(4×4)=16+12+12+48=88. Note that some or all of the high frequency regions 620, 630, and 640 may be downsampled with even larger filter sizes (e.g., 8×8 filter size) if so desired.

FIG. 6B illustrates an embodiment of a quantization coefficient coding scheme 650, which may be implemented on coefficients generated by the QM downsampling scheme 600. According to the scheme 600, the 4×4 region 612a generates a 4×4 region 662a, the 4×4 regions 612b, 612c, and 612d generate 2×2 regions 662b, 662c, and 662d respectively, the 8×8 regions 614, 616, and 618 generate 2×2 regions 664, 666, and 668 respectively, and the 16×16 regions 620, 630, and 640 generate 4×4 regions 670, 680, and 690 respectively. The region 662a comprises original (i.e., not downsampled) quantization coefficients, while all of the other regions comprise downsampled quantization coefficients. The scheme 650 may be part of a QM coding scheme (e.g., the QM encoding scheme 100). In the scheme 650, the regions 662a-662d may be further lossless coded to avoiding mapping error. Other regions including 664, 666, 668, 670, 680, and 690 may also be lossless coded and stored into a bitstream. Alternatively, since all other regions may be relatively less important than the regions 662a-662d, to further improve QM compression, downsampled quantization coefficients in all regions except regions 662a-662d may be lossy coded. Any suitable lossless and/or lossy coding algorithms may be used for the coefficients. For example, lossy coding may be realized by right bit shifting to reduce bit width of coefficients, which is described next.

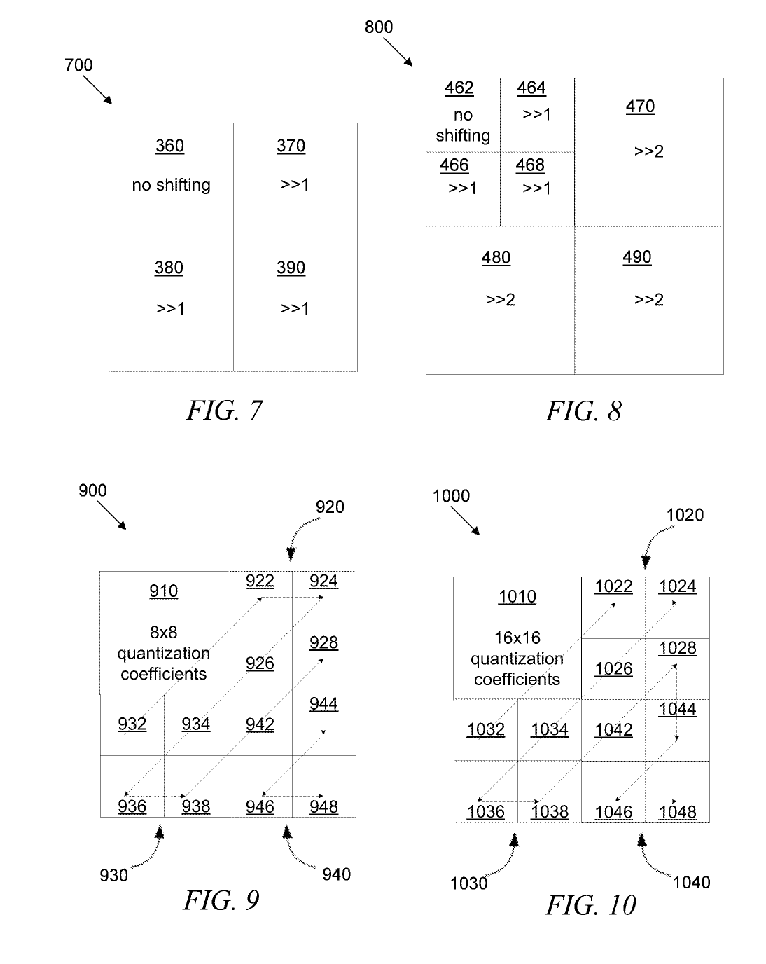

FIG. 7 illustrates an embodiment of a bit shifting scheme 700, which may be implemented on coefficients generated by the QM downsampling scheme 300. The scheme 700 may be considered a specific example of the scheme 350. In the scheme 700, different frequency parts of quantization coefficients are applied by a non-uniform bit shift operation to reduce the coded QM bits. Specifically, no bit shifting is applied to original quantization coefficients in the top-left region 360, while all downsampled quantization coefficients in the regions 370, 380, and 390 are right shifted by one bit (denoted as >>1 in FIG. 7). Assume, for example, each of the quantization coefficients has a bit width of 8 bits. Recall that the number of quantization coefficients the matrix 302 is reduced from 256 to 112 via the non-uniform QM downsampling scheme 300. Thus, a total number of bits needed to represent the QM 302 is reduced from 256*8=2048 bits to 8×8×8+(3*8×8)/(2×2)*7=848 bits. It should be understood that the quantization coefficients may be right shifted by any suitable number of bits (e.g., 1, 2, or more).

FIG. 8 illustrates an embodiment of a bit shifting scheme 800, which may be implemented on coefficients generated by the QM downsampling scheme 400. The scheme 800 may be considered a specific example of the scheme 450. In the scheme 800, different frequency parts of quantization coefficients are applied by a non-uniform bit shift operation to reduce the coded QM bits. Specifically, no bit shifting is applied to original quantization coefficients in the top-left region 460. Downsampled quantization coefficients in the regions 464, 466, and 468 are right shifted by one bit, and downsampled quantization coefficients in the regions 470, 480, and 490 are right shifted by two bits. Assume, for example, each of the quantization coefficients has a bit width of 8 bits. Recall that the number of quantization coefficients the matrix 402 is reduced from 1024 to 160 via the non-uniform QM downsampling scheme 400. Thus, a total number of bits needed to represent the QM 402 is reduced from 1024*8=8192 bits to 8×8×8 bit+(3*8×8)/(2×2)×7 bit+(3×16×16)/4×4×6 bit=1136 bits. It should be understood that, in the scheme 800, the quantization coefficients may be right shifted by any other number of bits (e.g., 3 or more). For example, a bit shifting scheme may right shift a first set of downsampled quantization coefficients in the region 464 by a first number of bits, and right shift a second set of downsampled quantization coefficients in the region 470 by a second number of bits, wherein the first and second numbers can have any value as long as the second number is greater than the first number.

As mentioned above, quantization coefficients may be scanned after non-uniform downsampling and before entropy encoding. Since non-uniform downsampling of quantization coefficients may lead to both original quantization coefficients (densely arranged) and downsampled quantization coefficients (more sparsely arranged), these coefficients may need to be scanned separately using the same scanning order or different scanning orders.

FIG. 9 illustrates an embodiment of a zigzag scanning scheme 900, which may be part of a QM coding scheme (e.g., the QM encoding scheme 100). As shown in FIG. 9, a region 910 comprises 8×8=64 original quantization coefficients, while each of regions 920, 930, 940 comprise 2×2=4 downsampled quantization coefficients if 4×4 filter is applied. Recall that the number of downsampled quantization coefficients depends on the size of the downsampling filter. Specifically, the region 920 comprises coefficients 922, 924, 926, and 928, the region 930 comprises coefficients 932, 934, 936, and 938, and the region 940 comprises coefficients 942, 944, 946, and 948. From descriptions above, this arrangement may be generated by downsampling all high frequency regions of a 16×16 QM with a filter size of 4×4. While if each of regions 920, 930, 940 is filter by a 2×2 filter, each of regions 920, 930, 940 comprises 2×2=4 sub-region. Specifically, the region 920 comprises sub-region 922, 924, 926, and 928, the region 930 comprises sub-region 932, 934, 936, and 938, and the region 940 comprises sub-region 942, 944, 946, and 948. Each sub-region comprises 2×2=4 downsampled quantization coefficients. From descriptions above, this arrangement may be generated by downsampling all high frequency regions of a 16×16 QM with a filter size of 2×2. The scheme 900 may be implemented on coefficients generated by any QM downsampling scheme, or by any bit shifting scheme if bit shifting is used.

In the zigzag scanning scheme 900, quantization coefficients located in the region 910 may be scanned following a conventional zigzag order, starting from the top-left corner coefficient and end with the bottom-right corner coefficient. Further, since the downsampled quantization coefficients are no longer located in a regular matrix structure, they may be scanned separately, but still following a zigzag order. As shown in FIG. 9, scanning follows the zigzag order of 932 (short for coefficient sub-region 932), 922, 924, 926, 934, 936, 938, 942, 928, 944, 946, and 948. A person of ordinary skill in the art will understand how to apply principles of this zigzag order to quantization coefficients generated using any other downsampling and/or bit shifting scheme. For example, if the regions 920-940 include more coefficients, zigzag scanning may be performed similarly.

FIG. 10 illustrates an embodiment of a zigzag scanning scheme 1000, which may be part of a QM coding scheme (e.g., the QM encoding scheme 100). As shown in FIG. 10, a region 1010 comprises 16×16=256 original quantization coefficients, while each of regions 1020, 1030, 1040 comprise 2×2=4 downsampled quantization coefficients if a 8×8 filter is applied. Specifically, the region 1020 comprises coefficients 1022, 1024, 1026, and 1028, the region 1030 comprises coefficients 1032, 1034, 1036, and 1038, and the region 1040 comprises coefficients 1042, 1044, 1046, and 1048. From descriptions above, this arrangement may be generated by downsampling all high frequency regions of a 32×32 QM with a filter size of 8×8. While if each of regions 1020, 1030, 1040 is filtered by a 4×4 filter, each of regions 1020, 1030, 1040 comprises 2×2=4 downsampled coefficients sub-region and each sub-region comprises 2×2=4 downsampled quantization coefficient. Specifically, the region 1020 comprises downsampled coefficients sub-region 1022, 1024, 1026, and 1028, the region 1030 comprises downsampled coefficients sub-region 1032, 1034, 1036, and 1038, and the region 1040 comprises downsampled coefficients sub-region 1042, 1044, 1046, and 1048. s. The scheme 1000 may be implemented on coefficients generated by any QM downsampling scheme, or by any bit shifting scheme if bit shifting is used.

In the zigzag scanning scheme 1000, quantization coefficients located in the region 1010 may be scanned following a conventional zigzag order, starting from the top-left corner coefficient and end with the bottom-right corner coefficient. Further, the downsampled quantization coefficients may be scanned separately, but still following a zigzag order. As shown in FIG. 10, scanning follows the zigzag order of 1032 (short for coefficient sub-region 1032), 1022, 1024, 1026, 1034, 1036, 1038, 1042, 1028, 1044, 1046, and 1048. A person of ordinary skill in the art will understand how to apply principles of this zigzag order to quantization coefficients generated using any other downsampling and/or bit shifting scheme.

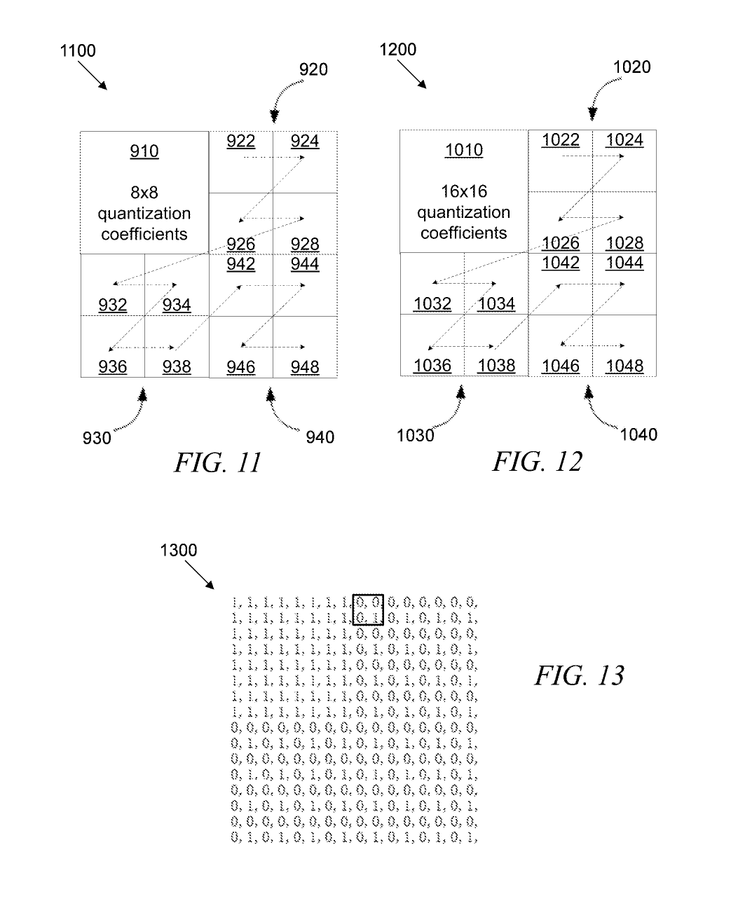

FIG. 11 illustrates an embodiment of a quantization coefficient scanning scheme 1100, which may be part of a QM coding scheme (e.g., the QM encoding scheme 100). As shown in FIG. 11, instead of following a zigzag order, scanning may be performed on the downsampled quantization coefficients generated from the top-right region 920, followed by downsampled quantization coefficients generated from the bottom-left region 930, followed by downsampled quantization coefficients generated from the bottom-right region 940. Specifically, scanning follows the order: 922 (short for coefficient 922), 924, 926, 932, 934, 936, 938, 942, 944, 946, and 948. A person of ordinary skill in the art will understand how to apply principles of this zigzag order to quantization coefficients generated using any other downsampling and/or bit shifting scheme. For example, if the regions 920-940 include more coefficients, scanning may be performed following the same principle.

FIG. 12 illustrates an embodiment of a quantization coefficient scanning scheme 1200, which may be part of a QM coding scheme (e.g., the QM encoding scheme 100). As shown in FIG. 12, instead of following a zigzag order, scanning may be performed on the downsampled quantization coefficients generated from the top-right region 1020, followed by downsampled quantization coefficients generated from the bottom-left region 1030, followed by downsampled quantization coefficients generated from the bottom-right region 1040. Specifically, scanning follows the order: 1022 (short for coefficient 1022), 1024, 1026, 1032, 1034, 1036, 1038, 1042, 1044, 1046, and 1048. A person of ordinary skill in the art will understand how to apply principles of this zigzag order to quantization coefficients generated using any other downsampling and/or bit shifting scheme. For example, if the regions 1020-1040 include more coefficients, scanning may be performed following the same principle.

As mentioned previously, in a video codec (encoder or decoder), upsampling may be performed to reconstruct a QM. While downsampling reduces a number of quantization coefficients in the QM, upsampling recovers or restores the number of quantization coefficients in the QM. Accordingly, depending on the filter size of a downsampling filter, which may be 1×1, 2×2, 4×4, etc., upsampling may be operated on different sizes of windows. For example, if a 2×2 downsampling filter was used in downsampling a QM, upsampling should generate 2×2=4 upsampled quantization coefficient values from one downsampled quantization coefficient. Further, upsampling may use any suitable algorithm.

FIG. 13 illustrates an embodiment of an upsampling precision map 1300 comprising 0s and 1s, on which the upsampling algorithm is based. Assume upsampling is implemented to reconstruct a 16×16 QM, whose high frequency regions were downsampled using 2×2 downsampling filters. The upsampling algorithm may duplicate coefficient values such that windows with size equaling the filter size end up with identical quantization coefficients. ‘1’ positions will retain quantization coefficients, while ‘0’ positions are filled with quantization coefficients from their corresponding ‘1’s located in the same window. For the other downsampled quantization coefficients, since 2×2 downsampling filters were used in downsampling, every neighboring 2×2=4 coefficients are reconstructed as a window. Within the window, reconstructed quantization coefficients have the same value, that is, duplicating ‘1’ position value to ‘0’ positions.

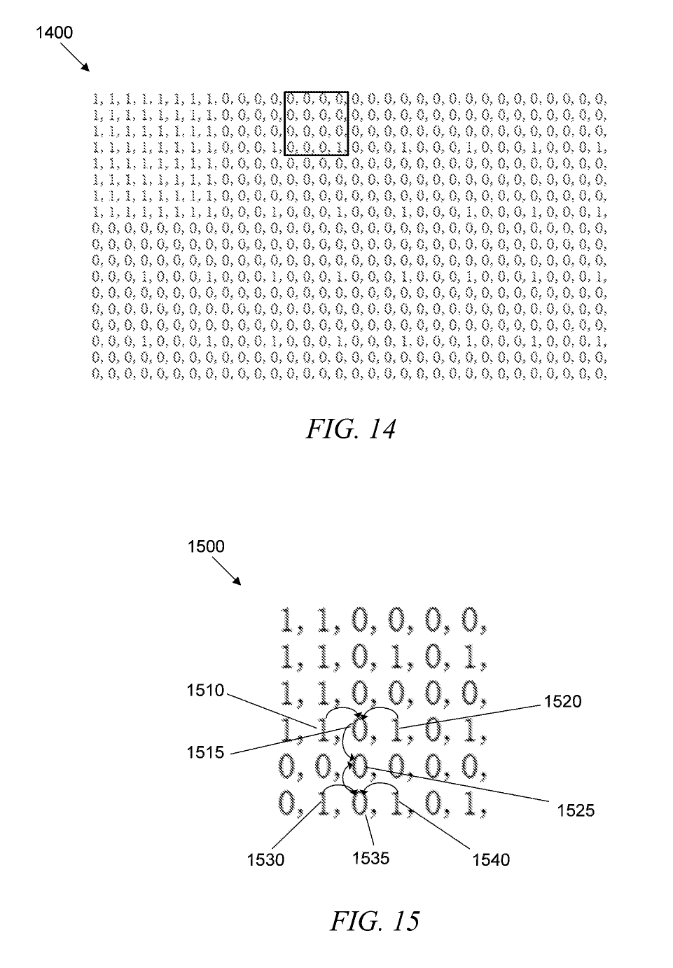

FIG. 14 illustrates an embodiment of an upsampling precision map 1400 comprising 0s and 1s, on which the upsampling algorithm is based. Assume upsampling is implemented to reconstruct a 32×32 QM, whose high frequency regions were downsampled using 4×4 downsampling filters. The upsampling algorithm may duplicate coefficient values such that windows with size equaling the filter size end up with identical quantization coefficients. For the other downsampled quantization coefficients, since 4×4 downsampling filters were used in downsampling, every neighboring 4×4=16 coefficients are reconstructed as a window. Within the window, reconstructed quantization coefficients have the same value, that is, duplicating ‘1’ position value to ‘0’ positions.

FIG. 15 illustrates an embodiment of an upsampling algorithm 1500, which may be implemented to reconstruct a QM. The upsampling algorithm 1500 may interpolate a quantization coefficient based on a plurality of quantization coefficients whose values are known or have already been interpolated. FIG. 15 only shows some of the coefficient positions in a QM for illustrative purposes. As shown in FIG. 15, ‘1’ positions 1510, 1520, 1530, and 1540 have downsampled quantization coefficients. In order to fill the other ‘0’ positions, interpolating may be used to generate the reconstructed value. Specifically, a coefficient on position 1515 may be generated by interpolating coefficients on positions 1510 and 1520. Similarly, a coefficient on position 1535 may be generated by interpolating coefficients on positions 1530 and 1540. Then, a coefficient on position 1525 may be generated by interpolating coefficients on positions 1515 and 1535. Note that interpolation herein may be realized using any suitable algorithm (e.g., taking an average of the two known values).

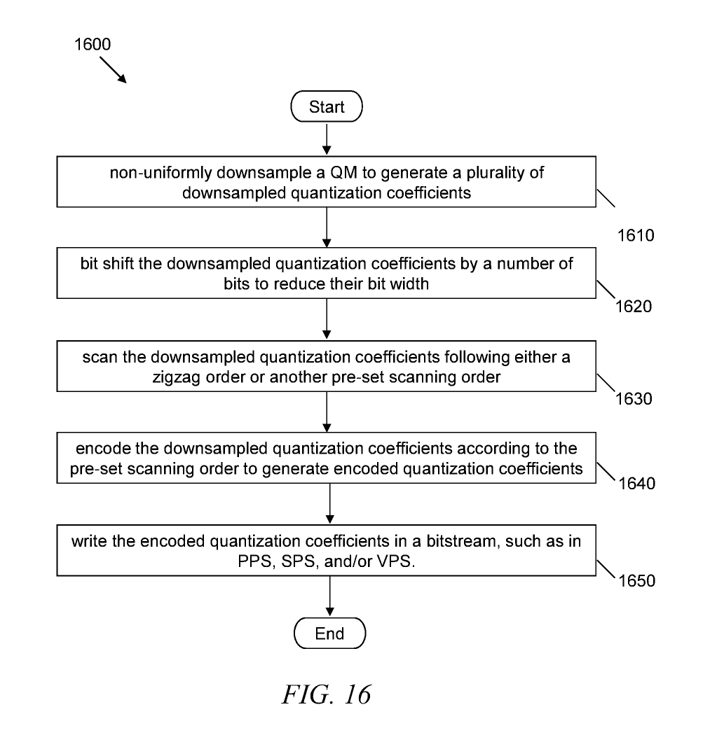

FIG. 16 illustrates an embodiment of a QM encoding method 1600, which may be implemented on an encoding side comprising a video encoder (e.g., the video encoder 10). The method 1600 may operate on a relatively large QM (e.g., 16×16 or 32×32) divided into multiple regions, which may be rectangular or non-rectangular. Suppose the QM comprises at least a first region and a second region, wherein the first region comprises a top-left corner quantization coefficient. For example, the first region may the region 310 in FIG. 3A, while the second region may be the region 320, 330, 340, or a non-rectangular region encompassing the regions 320, 330, and 340. The method 1600 may start in step 1610, in which the QM may be non-uniformly downsampled using one or more downsampling filters with one or more filter sizes to generate a plurality of downsampled quantization coefficients. In one embodiment, non-uniformly downsampling the QM comprises downsampling the second region using a downsampling filter with a filter size greater than 1×1, wherein no downsampling is performed in the first region. In another embodiment, non-uniformly downsampling the QM comprises downsampling the first region using a downsampling filter with a first filter size, and downsampling the second region using a downsampling filter with a second filter size greater than the first filter size.

In step 1610, the QM may further comprise a third region (e.g., with the first, second, and third regions being regions 412, 414, and 420 in FIG. 4A respectively), wherein the third region is further away from the top-left corner quantization coefficient than the second region. That is, a minimal distance between the third region and the top-left corner quantization coefficient (e.g., minimal distance between region 420 and top-left corner coefficient is 16) is longer than a minimal distance between the second region and the top-left corner quantization coefficient (e.g., minimal distance between regions 414 and top-left corner coefficient is 8). In this case, non-uniformly downsampling the QM may further comprise downsampling the third region using a second downsampling filter with a filter size greater than the filter size used in the second region. Similarly, if additional regions are included in the QM, the same principle can be applied to downsampling the additional regions.

In step 1620, the method 1600 may bit shift the downsampled quantization coefficients by a number of bits to reduce their bit width. If no downsampling was performed in the first region, no bit shifting is performed on any quantization coefficient located in the first region. Note that other lossy coding or lossless coding schemes may also be used in this step.

In step 1630, the method 1600 may scan the downsampled quantization coefficients following either a zigzag order or another pre-set scanning order. As described previously with respect to FIGS. 11 and 12, the pre-set order is: downsampled quantization coefficients generated from the top-right region, followed by downsampled quantization coefficients generated from the bottom-left region, and followed by downsampled quantization coefficients generated from the bottom-right region.

In step 1640, the method 1600 may use an entropy encoder to encode the downsampled quantization coefficients according to the pre-set scanning order to generate encoded quantization coefficients. In step 1650, the method 1600 may write the encoded quantization coefficients in part of a bitstream, such as PPS, SPS, and/or VPS. Note that the method 1600 may only be a portion of necessary steps in encoding a picture, thus other steps may be added as appropriate.

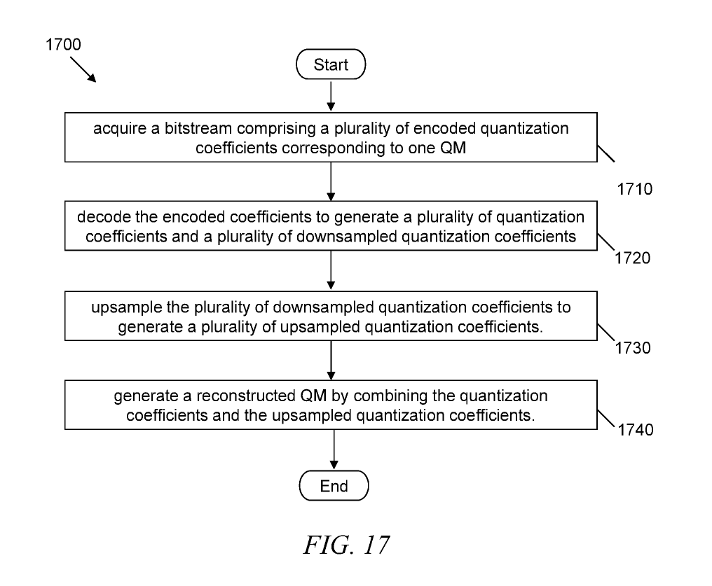

FIG. 17 illustrates an embodiment of a QM decoding method 1700, which may be implemented by a video decoder. In a starting step 1710, the method 1700 may acquire or obtain a received bitstream comprising a plurality of encoded quantization coefficients corresponding to one QM. In step 1720, the method 1700 may entropy decode the encoded quantization coefficients to generate a plurality of quantization coefficients (not downsampled) and a plurality of downsampled quantization coefficients.

In step 1730, the method 1700 may upsample the plurality of downsampled quantization coefficients to generate a plurality of upsampled quantization coefficients. As described with respect to FIGS. 13 and 14, upsampling the plurality of downsampled quantization coefficients may comprise duplicating coefficient values such that N×N neighboring coefficient positions end up having identical quantization coefficients, where N×N is the filter size of a downsampling filter based on which at least part of the encoded quantization coefficients was generated. For example, if a 2×2 downsampling filter was used in the process of generating some of the encoded quantization coefficients, every 2×2 neighboring positions in the reconstructed QM may end up having equal coefficient values. Alternatively, as described with respect to FIG. 15, upsampling the plurality of downsampled quantization coefficients may comprise interpolating a quantization coefficient based on a plurality of neighboring quantization coefficients (e.g., a left and a right neighboring coefficient) whose values are known or have been previously interpolated.

In step 1740, the method 1700 may generate a reconstructed QM by combining the quantization coefficients and the upsampled quantization coefficients. The step 1740 may simply mean that the reconstructed QM is formed after all of its positions are filled with coefficient values. Note that the method 1700 may be followed by other steps, such as decoding video blocks using the reconstructed QM. Also, variations of the method 1700 falls in the scope of the present disclosure. For example, if all coefficients in the bitstream had been downsampled, step 1720 may generate only downsampled quantization coefficients.

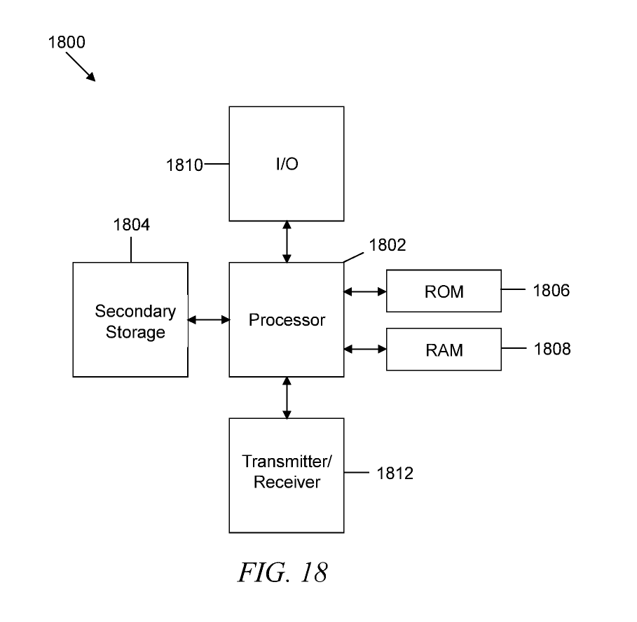

The schemes described above may be implemented on a network component, such as a computer or network component with sufficient processing power, memory resources, and network throughput capability to handle the necessary workload placed upon it. FIG. 18 is a schematic diagram of an embodiment of a network component or node 1800 suitable for implementing one or more embodiments of the methods disclosed herein, such as the QM encoding scheme 100, the QM decoding scheme 200, the QM downsampling scheme 300, the quantization coefficient coding scheme 350, the QM downsampling scheme 400, the quantization coefficient coding scheme 450, the QM downsampling scheme 500, the quantization coefficient coding scheme 550, the QM downsampling scheme 600, the quantization coefficient coding scheme 650, the bit shifting scheme 700, the bit shifting scheme 800, the zigzag scanning scheme 900, the zigzag scanning scheme 1000, the quantization coefficient scanning scheme 1100, the quantization coefficient scanning scheme 1200, algorithm based on the upsampling precision map 1300, algorithm based on the upsampling precision map 1400, the upsampling algorithm 1500, the QM encoding method 1600, and the QM decoding method 1700. Further, the network node 1800 may be configured to implement any of the apparatuses described herein, such as the video encoder 10 and/or a video decoder.

The network node 1800 includes a processor 1802 that is in communication with memory devices including secondary storage 1804, read only memory (ROM) 1806, random access memory (RAM) 1808, input/output (I/O) devices 1810, and transmitter/receiver (or transceiver) 1812. Although illustrated as a single processor, the processor 1802 is not so limited and may comprise multiple processors. The processor 1802 may be implemented as one or more central processor unit (CPU) chips, cores (e.g., a multi-core processor), field-programmable gate arrays (FPGAs), application specific integrated circuits (ASICs), and/or digital signal processors (DSPs). The processor 1802 may be configured to implement any of the schemes described herein, including the QM encoding scheme 100, the QM decoding scheme 200, the QM downsampling scheme 300, the quantization coefficient coding scheme 350, the QM downsampling scheme 400, the quantization coefficient coding scheme 450, the QM downsampling scheme 500, the quantization coefficient coding scheme 550, the QM downsampling scheme 600, the quantization coefficient coding scheme 650, the bit shifting scheme 700, the bit shifting scheme 800, the zigzag scanning scheme 900, the zigzag scanning scheme 1000, the quantization coefficient scanning scheme 1100, the quantization coefficient scanning scheme 1200, algorithm based on the upsampling precision map 1300, algorithm based on the upsampling precision map 1400, the upsampling algorithm 1500, the QM encoding method 1600, and the QM decoding method 1700. The processor 1802 may be implemented using hardware or a combination of hardware and software.

The secondary storage 1804 is typically comprised of one or more disk drives or tape drives and is used for non-volatile storage of data and as an over-flow data storage device if the RAM 1808 is not large enough to hold all working data. The secondary storage 1804 may be used to store programs that are loaded into the RAM 1808 when such programs are selected for execution. The ROM 1806 is used to store instructions and perhaps data that are read during program execution. The ROM 1806 is a non-volatile memory device that typically has a small memory capacity relative to the larger memory capacity of the secondary storage 1804. The RAM 1808 is used to store volatile data and perhaps to store instructions. Access to both the ROM 1806 and the RAM 1808 is typically faster than to the secondary storage 1804.

The transmitter/receiver 1812 may serve as an output and/or input device of the network node 1800. For example, if the transmitter/receiver 1812 is acting as a transmitter, it may transmit data out of the network node 1800. If the transmitter/receiver 1812 is acting as a receiver, it may receive data into the network node 1800. The transmitter/receiver 1812 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. The transmitter/receiver 1812 may enable the processor 1802 to communicate with an Internet or one or more intranets. I/O devices 1810 may include a video monitor, liquid crystal display (LCD), touch screen display, or other type of video display for displaying video, and/or may include a video recording device for capturing video. I/O devices 1810 may also include one or more keyboards, mice, or track balls, or other well-known input devices.

It is understood that by programming and/or loading executable instructions onto the network node 1800, at least one of the processor 1802, the secondary storage 1804, the RAM 1808, and the ROM 1806 are changed, transforming the network node 1800 in part into a particular machine or apparatus (e.g., a video codec having the functionality taught by the present disclosure). The executable instructions may be stored on the secondary storage 1804, the ROM 1806, and/or the RAM 1808 and loaded into the processor 1802 for execution. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means+/−10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method of coding a quantization matrix (QM) comprising:
non-uniformly downsampling the QM to generate a plurality of downsampled quantization coefficients.

2. The method of claim 1, wherein the QM comprises a first region and a second region, wherein the first region comprises a top-left corner quantization coefficient, wherein non-uniformly downsampling the QM comprises:
downsampling the first region using a downsampling filter with a first filter size; and
downsampling the second region using a downsampling filter with a second filter size greater than the first filter size.

3. The method of claim 1, wherein the QM comprises a first region and a second region, wherein the first region comprises a top-left corner quantization coefficient, wherein non-uniformly downsampling the QM comprises downsampling the second region using a downsampling filter with a first filter size greater than 1×1, and wherein no downsampling is performed in the first region.

4. The method of claim 3, wherein the QM further comprises a third region, wherein the third region is further away from the top-left corner quantization coefficient than the second region, and wherein non-uniformly downsampling the QM further comprises downsampling the third region using a second downsampling filter with a second filter size greater than the first filter size.

5. The method of claim 4, wherein the first filter size is 2×2 and the second filter size is 4×4.

6. The method of claim 3, wherein the QM further comprises a fourth region, wherein the fourth region is further away from the top-left corner quantization coefficient than the third region, and wherein non-uniformly downsampling the QM further comprises downsampling the fourth region using a third downsampling filter with the second filter size.

7. The method of claim 3, wherein the first region comprises a plurality of quantization coefficients including the top-left corner quantization coefficient, the method further comprising:
coding the plurality of quantization coefficients using lossless coding; and
coding the plurality of downsampled quantization coefficients using lossless or lossy coding.

8. The method of claim 3, further comprising bit shifting the downsampled quantization coefficients by a number of bits to reduce their bit width, wherein no bit shifting is performed on any quantization coefficient located in the first region.

9. The method of claim 4, wherein downsampling the second and third regions generates a first set and a second set of downsampled quantization coefficients, respectively, the method comprising:
right shifting the first set of downsampled quantization coefficients by a first number of bits; and
right shifting the second set of downsampled quantization coefficients by a second number of bits, wherein the second number is greater than the first number,
and wherein no right shifting is performed on any quantization coefficient located in the first region.

10. The method of claim 3, further comprising scanning the downsampled quantization coefficients following a zigzag order, wherein the zigzag order ends with a downsampled quantization coefficient located at a bottom-right corner.

11. The method of claim 3, wherein the three rectangular regions comprises a top-right region, a bottom-left region, and a bottom-right region, the method further comprising scanning the downsampled quantization coefficients following a pre-set scanning order, which is:
downsampled quantization coefficients generated from the top-right region, followed by
downsampled quantization coefficients generated from the bottom-left region, followed by,
downsampled quantization coefficients generated from the bottom-right region.

12. A method of video decoding comprising:
acquiring a bitstream comprising a plurality of encoded quantization coefficients corresponding to one quantization matrix (QM);
decoding the encoded quantization coefficients to generate a plurality of quantization coefficients and a plurality of downsampled quantization coefficients;
upsampling the plurality of downsampled quantization coefficients to generate a plurality of upsampled quantization coefficients; and
generating a reconstructed QM by combining the quantization coefficients and the upsampled quantization coefficients.

13. The method of claim 12, wherein the plurality of quantization coefficients and the plurality of downsampled quantization coefficients are the result of non-uniformly downsampling the QM.

14. The method of claim 13, wherein the QM comprises a first region and a second region, wherein the first region comprises a top-left corner quantization coefficient, wherein non-uniformly downsampling the QM comprises downsampling the second region using a downsampling filter with a first filter size greater than 1×1, and wherein no downsampling is performed in the first region.

15. The method of claim 14, wherein the QM further comprises a third region, wherein the third region is further away from the top-left corner quantization coefficient than the second region, and wherein non-uniformly downsampling the QM further comprises downsampling the third region using a second downsampling filter with a second filter size greater than the first filter size.

16. The method of claim 12, wherein generating the upsampled quantization coefficients comprises interpolating a quantization coefficient based on a plurality of neighboring quantization coefficients whose values are known or have been previously interpolated.

17. The method of claim 16, wherein the quantization coefficient is located on a “0” position between “1” positions at which the plurality of quantization coefficients are located, and wherein the “0” and “1” positions are indicated by a upsampling precision map.

18. The method of claim 2, wherein upsampling the plurality of downsampled quantization coefficients is performed such that coefficients in a window of the reconstructed QM with a window size equaling the filter size end up with identical quantization coefficients.

19. An apparatus used in video decoding comprising:
a processor configured to:
acquire a bitstream comprising a plurality of encoded quantization coefficients corresponding to one quantization matrix (QM);
decode the encoded quantization coefficients to generate a plurality of quantization coefficients and a plurality of downsampled quantization coefficients;
upsample the plurality of downsampled quantization coefficients to generate a plurality of upsampled quantization coefficients; and
generate a reconstructed QM by combining the quantization coefficients and the upsampled quantization coefficients.

20. The apparatus of claim 19, wherein generating the upsampled quantization coefficients comprises interpolating a quantization coefficient based on a plurality of neighboring quantization coefficients whose values are known or have been previously interpolated.
